(19) United States
(12) Patent Application Publication
(10) Pub. No.: US 2025/0106916 A1
(43) Pub. Date: Mar. 27, 2025

(54) DETERMINING SIDELINK CONNECTION TIMERS FOR COMMUNICATION ESTABLISHMENT VIA A SIDELINK RELAY

(71) Applicant: Lenovo (Singapore) Pte. Ltd., New Tech Park (SG)

(72) Inventors: Prateek Basu Mallick, Dreieich (DE); Karthikeyan Ganesan, Kronberg im Taunus (DE); Joachim Löhr, Wiesbaden (DE); Ravi Kuchibhotla, Chicago, IL (US)

(21) Appl. No.: 18/730,736

(22) PCT Filed: Jan. 23, 2023
(86) PCT No.: PCT/IB2023/050562

§ 371 Date: Jul. 19, 2024

Related U.S. Application Data
(60) Provisional application No. 63/302,006, filed on Jan. 21, 2022.

(51) Int. Cl. H04W 76/14

(52) U.S. Cl. CPC H04W 76/14

(57) ABSTRACT

Apparatuses, methods, and systems are disclosed for configuring sidelink (“SL”) connection timers. One method includes receiving a set of connection timers from a first system information block (“SIB”) transmission of a serving node and receiving first set of SL connection timers from an additional SIB of the serving node. The method includes determining a second set of SL connection timers for communication establishment with a network node-base station using a UE-to-Network (“U2N”) SL relay UE, where a respective value for each timer in the second set of SL connection timers is determined based at least in part on the first set of SL connection timers. The method includes using a respective connection timer to supervise communication establishment with the base station via the U2N SL relay UE.

### CROSS-REFERENCE TO RELATED APPLICATIONS

This application claims priority to U.S. Provisional Patent Application No. 63/287,251 entitled “SIGNALING CONNECTION ESTABLISHMENT TIMERS TO A SIDELINK REMOTE UE” and filed on 21 Jan. 2023 for Prateek Basu Mallick, Karthikeyan Ganesan, Joachim Löhr, and Ravi Kuchibhotla, which application is incorporated herein by reference.

### FIELD

The subject matter disclosed herein relates generally to wireless communications and more particularly relates to configuring connection establishment timers for sidelink communication, e.g., for communication establishment between a remote User Equipment (“UE”) and a network node using a UE-to-Network (“U2N”) sidelink relay.

### BACKGROUND

In sidelink communication, a UE is able to communicate directly with another UE and without relaying its messages via a wireless network. In Third Generation Partnership Project (“3GPP”), sidelink communication may also be used to extend the service area of a Radio Access Network (“RAN”) by having an in-coverage UE relay signaling (i.e., via sidelink communication) between an out-of-coverage UE and the serving network node (e.g., a RAN node).

### BRIEF SUMMARY

Disclosed are procedures related to configuring connection establishment timers for sidelink communication, also referred to herein as “sidelink connection timers.” Said procedures may be implemented by apparatus, systems, methods, or computer program products.

One method at a UE includes receiving a set of connection timers from a first system information block transmission of a serving node and receiving a first set of sidelink connection timers from an additional system information block of the serving node. The method includes determining a second set of sidelink connection timers for communication establishment with a network node using a U2N sidelink relay UE, where a respective value for each timer in the second set of sidelink connection timers is determined based at least in part on the first set of sidelink connection timers. The method includes using a respective connection timer to supervise communication establishment with the network node via the U2N sidelink relay UE.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for configuring sidelink connection timers;

FIG. 2 is a block diagram illustrating one embodiment of a New Radio (“NR”) protocol stack:

FIG. 3 is a diagram illustrating one embodiment of connection establishment procedures between an out-of-coverage UE and a serving network node via a U2N sidelink relay UE;

FIG. 4 is a diagram illustrating one embodiment of connection reestablishment procedures between an out-of-coverage UE and a serving network node via a U2N sidelink relay UE:

FIG. 5 is a diagram illustrating one embodiment of connection resume procedures between an out-of-coverage UE and a serving network node via a U2N sidelink relay UE;

FIG. 6 is a diagram illustrating one embodiment of connection resume procedures with network release or suspend between an out-of-coverage UE and a serving network node via a U2N sidelink relay UE:

FIG. 7 is a diagram illustrating one embodiment of an Information Element (“IE”) containing a set of UE timers and constants:

FIG. 8 is a diagram illustrating one embodiment of an IE containing a set of sidelink-specific UE timers and constants:

FIG. 8 is a diagram illustrating one embodiment of a sixth interlacing scheme for sidelink operation:

FIG. 9A is a diagram illustrating one embodiment of System Information Block #1 (“SIB1”) containing a set of UE timers and constants and an additional offset time for connection procedures via sidelink relays:

FIG. 9B is a continuation of the SIB1 depicted in FIG. 9A:

FIG. 10 is a block diagram illustrating one embodiment of a sidelink relay arrangement and associated connection timers:

FIG. 11 is a block diagram illustrating one embodiment of a user equipment apparatus that may be used for configuring sidelink connection timers:

FIG. 12 is a block diagram illustrating one embodiment of a network apparatus that may be used for configuring sidelink connection timers; and

FIG. 13 is a flowchart diagram illustrating one embodiment of a first method for configuring sidelink connection timers.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “at least one of A, B and C” includes only A, only B, only C, a combination of A and B, a combination of B and C, a combination of A and C or a combination of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures Like numbers refer to like elements in all figures, including alternate embodiments of like elements.

configuring sidelink connection timers. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

To achieve coverage extension a remote UE needs to select and reselect UE-to-Network (“U2N”) Relay from time to time due to radio conditions and/or due to upper layer criteria. Radio conditions may be configured (or preconfigured) such that when the radio quality (e.g., Reference Signal Received Power (“RSRP”) measurements) of the current Serving-Relay UE goes below a certain threshold, the remote UE searches for candidate relays that meeting upper layer criteria (if any) and are above a certain (pre) configured threshold.

As a prelude, sidelink-based relaying functionality was studied for sidelink/network coverage extension and power efficiency improvement, considering wider range of applications and services. The Study of “Study on NR Sidelink Relay” has been carried out in an earlier phase of Rel. 17 and it covered the enhancements and solutions necessary to support the UE-to-network Relay coverage extension. The accomplishments of the study for Sidelink Relay are documented in 3GPP Technical Report (“TR”) 38.836.

A remote UE, like a direct Uu UE, needs to get Radio Resource Control (“RRC”) Connected to avail network's service e.g., to initiate voice call or initiate data services etc. To this end, an RRC Idle remote UE needs to establish RRC Connection, an RRC Inactive remote UE needs to Resume RRC Connection and up on a Radio Link failure (“RLF”), the remote UE may need to re-establish the RRC Connection. On the Uu interface for direct link between a UE and the 5G/NR Node B (“gNB”), these three procedures are supervised using three respective timers T300, T319 and T301, respectively.

Because the time supervision will be necessary for executing these procedure by a remote UE as well, it was agreed to introduce new fields in SIB1 for T300-like/T319-like/T301-like timers to be used by L2 remote UE. For these timers, on top of existing stop conditions as for the legacy timers, add extra stop condition for relayed scenario, i.e., “the (re)selected relay becomes unsuitable” for T300-like timer, “relay (re)selection” for T319-like timer, and “the (re)selected relay becomes unsuitable” for T301-like timer.

It was also agreed not to introduce new T311-like timer for L2 remote UE. Add extra stop-condition in the legacy T311 timer for relayed scenario, i.e., “upon (re)selection of a suitable relay”.

Because the agreement proposes to add three new timers for the said purpose in SIB1, it will increase the SIB1 signaling by at least 9 bits or even by 10 bits when one considers that an Information Element (“IE”) similar to UE-TimersAndConstants (i.e., defined as part of SIB1 definition in 3GPP Technical Specification (“TS”) 38.331 (v16.6.0) for sidelink (“SL”) needs to be introduced in an optional manner.

SIB1 is a cell-specific System Information Block (“SIB”) that contains information relevant when evaluating if a UE is allowed to access a cell and defines the scheduling of other system information. SIB1 also contains radio resource configuration information that is common for all UEs and barring information applied to the unified access control. In 3GPP, the SIB1 is associated with the Broadcast Control Channel (“BCCH”) logical channel.

SIB1 scheduling is very expensive since the SIB1 is transmitted on the Downlink Shared Channel (“DL-SCH”) (a transport channel) with a periodicity of 160 ms and variable transmission repetition periodicity within 160 ms as specified in 3GPP TS 38.213, clause 13. The default transmission repetition periodicity of SIB1 is 20 ms, but the actual transmission repetition periodicity is up to network implementation. For Synchronization Signal Block (“SSB”) and Control Resource Set (“CORESET”) multiplexing pattern 1, SIB1 repetition transmission period is 20 ms. For SSB and CORESET multiplexing pattern 2/3, SIB1 transmission repetition period is the same as the SSB period (see 3GPP TS 38.213, clause 13). SIB1 includes information regarding the availability and scheduling (e.g., mapping of System Information Blocks (“SIBs”) to System Information (“SI”) message, periodicity, SI-window size) of other SIBs with an indication whether one or more SIBs are only provided on-demand and, in that case, the configuration needed by the UE to perform the SI request.

Therefore, it is generally not a good idea to add 10 bits to SIB1 signaling, especially when beam sweeping needs to be used by a base station for transmission of SIB1. This disclosure provides alternative solutions.

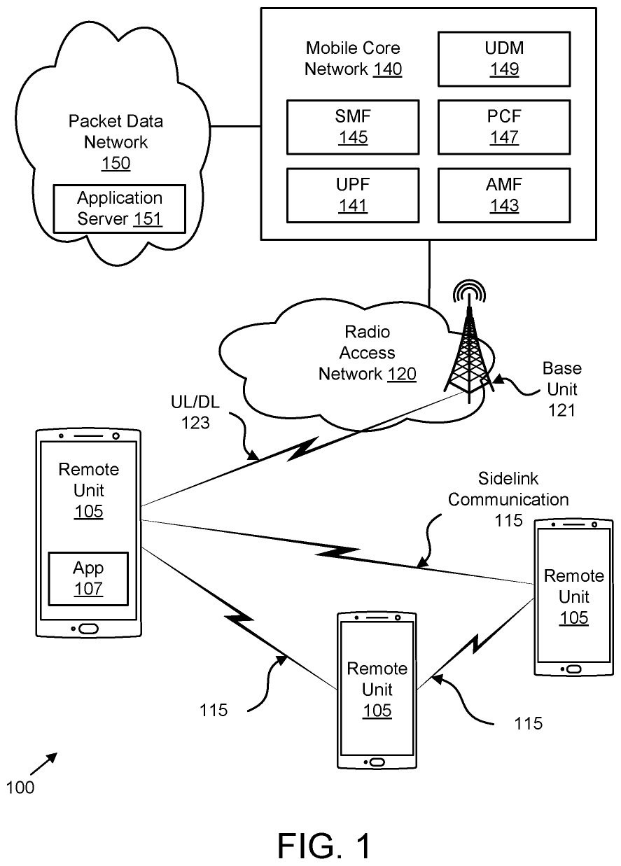

FIG. 1 depicts a wireless communication system 100 for configuring sidelink connection timers, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the Fifth Generation (“5G”) system specified in the 3GPP specifications. For example, the RAN 120 may be a Next Generation Radio Access Network (“NG-RAN”), implementing NR Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example, the Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art.

In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above). The remote unit 105 allows a user to access network services. In various embodiments, the interface between the remote unit 105 and the network is the radio interface. The remote unit 105 may be subdivided into a number of domains, the domains being separated by reference points. For example, the remote unit 105 may be subdivided into the Universal Integrated Circuit Card (“UICC”) domain and the ME Domain. The ME Domain can further be subdivided into one or more Mobile Termination (“MT”) and TE components, with connectivity between multiple functional groups.

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Furthermore, the UL communication signals may comprise one or more uplink channels, such as the Physical Uplink Control Channel (“PUCCH”) and/or Physical Uplink Shared Channel (“PUSCH”), while the DL communication signals may comprise one or more DL channels, such as the Physical Downlink Control Channel (“PDCCH”) and/or Physical Downlink Shared Channel (“PDSCH”). Here, the RAN 120 is an intermediate network that provides the remote units 105 with access to the mobile core network 140.

In various embodiments, the remote units 105 may communicate directly with each other (e.g., device-to-device communication) using sidelink communication links 115. Here, sidelink transmissions may occur on sidelink resources. A remote unit 105 may be provided with different sidelink communication resources according to different allocation modes. As used herein, a “resource pool” refers to a set of resources assigned for sidelink operation. A resource pool consists of a set of resource blocks (i.e., Physical Resource Blocks (“PRB”)) over one or more time units (e.g., Orthogonal Frequency Division Multiplexing (“OFDM”) symbols, subframes, slots, subslots, etc.). In some embodiments, the set of resource blocks comprises contiguous PRBs in the frequency domain. A PRB, as used herein, consists of twelve consecutive subcarriers in the frequency domain.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or Packet Data Network (“PDN”) connection) with the mobile core network 140 via the RAN 120. The PDU session represents a logical connection between the remote unit 105 and the User Plane Function (“UPF”) 141. The mobile core network 140 then relays traffic between the remote unit 105 and the application server 151 in the packet data network 150 using the PDU session (or other data connection).

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5Q1”).

In the context of a 4G/LTE system, such as the Evolved Packet System (“EPS”), a PDN connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW”) (not shown in FIG. 1) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a gNB, a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121.

Note that during NR operation on unlicensed spectrum (referred to as “NR-U”), the base unit 121 and the remote unit 105 communicate over unlicensed (i.e., shared) radio spectrum. Similarly, during LTE operation on unlicensed spectrum (referred to as “LTE-U”), the base unit 121 and the remote unit 105 also communicate over unlicensed (i.e., shared) radio spectrum.

In one embodiment, the mobile core network 140 is a 5G core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”, also referred to as “Unified Data Repository”). Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Stratum (“NAS”) signaling, NAS ciphering and integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation and management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for case of illustration, but their support is assumed.

To facilitate configuring sidelink connection timers, the base unit 121 may transmit a sidelink configuration to a remote unit 105, where the remote unit 105 uses the sidelink configuration to identify relevant sidelink connection timers, and/or relevant sidelink communication resources. In various embodiments, the sidelink configuration may be transmitted in SI, such as SIB1 or another SIB containing sidelink configuration information.

In various embodiments, a remote unit 105 may be provided with different sidelink communication resources for different allocation modes. Mode-1 corresponds to a NR-based network-scheduled sidelink communication mode, wherein the in-coverage RAN 120 indicates resources for use in sidelink operation, including resources of one or more resource pools. Mode-2 corresponds to a NR-based UE-scheduled sidelink communication mode (i.e., UE-autonomous selection), where the remote unit 105 select a resource pools and resources therein from a set of candidate pools. Mode-3 corresponds to an LTE-based network-scheduled sidelink communication mode. Mode-4 corresponds to an LTE-based UE-scheduled sidelink communication mode (i.e., UE-autonomous selection).

While FIG. 1 depicts components of a 5G RAN and a 5G core network, the described embodiments for configuring sidelink connection timers apply to other types of communication networks and RATs, including IEEE 802.11 variants, Global System for Mobile Communications (“GSM”) (i.e., a 2G digital cellular network), General Packet Radio Service (“GPRS”), Universal Mobile Telecommunications System (“UMTS”), LTE variants, CDMA2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station/base unit, but it is replaceable by any other radio access node, e.g., gNB, ng-eNB, eNB, Base Station (“BS”), base station unit, Access Point (“AP”), NR BS, 5G NB, Transmission and Reception Point (“TRP”), etc. Additionally, the term “UE” is used for the mobile station/remote unit, but it is replaceable by any other remote device, e.g., remote unit, MS, ME, etc.

Further, the operations are described mainly in the context of 5G NR. However, the below described solutions/methods are also equally applicable to other mobile communication systems configuring sidelink connection timers.

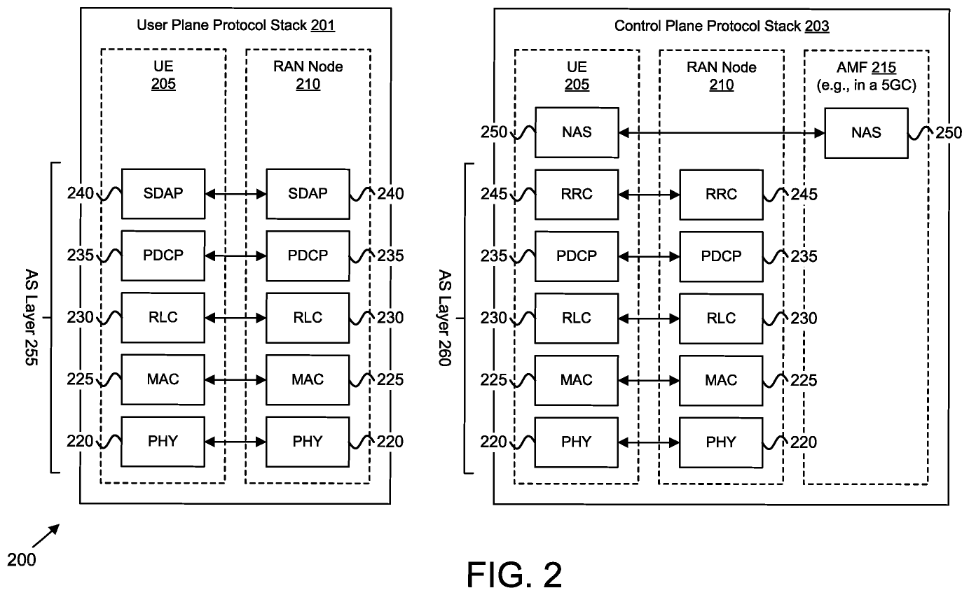

FIG. 2 depicts an NR protocol stack 200, according to embodiments of the disclosure. While FIG. 2 shows the UE 205, the RAN node 210 and an AMF 215 in a 5G core network (“5GC”), these are representatives of a set of remote units 105 interacting with a base unit 121 and a mobile core network 140. As depicted, the NR protocol stack 200 comprises a User Plane protocol stack 201 and a Control Plane protocol stack 203. The User Plane protocol stack 201 includes a physical (“PHY”) layer 220, a Medium Access Control (“MAC”) sublayer 225, the Radio Link Control (“RLC”) sublayer 230, a Packet Data Convergence Protocol (“PDCP”) sublayer 235, and Service Data Adaptation Protocol (“SDAP”) sublayer 240. The Control Plane protocol stack 203 includes a PHY layer 220, a MAC sublayer 225, an RLC sublayer 230, and a PDCP sublayer 235. The Control Plane protocol stack 203 also includes an RRC layer 245 and a NAS layer 250.

The Access Stratum (“AS”) layer 255 (also referred to as “AS protocol stack”) for the User Plane protocol stack 201 consists of at least SDAP, PDCP, RLC and MAC sublayers, and the physical layer. The AS layer 260 for the Control Plane protocol stack 203 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC layer 245 and the NAS layer 250 for the control plane and includes, e.g., an IP layer and/or PDU Layer (not depicted) for the user plane. L1 and L2 are referred to as “lower layers,” while L3 and above (e.g., transport layer, application layer) are referred to as “higher layers” or “upper layers.”

The PHY layer 220 offers transport channels to the MAC sublayer 225. The PHY layer 220 may perform a beam failure detection procedure using energy detection thresholds. In certain embodiments, the PHY layer 220 may send an indication of beam failure to a MAC entity at the MAC sublayer 225. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the core network (e.g., 5GC). The RRC layer 245 provides functions for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and an AMF 215 in the 5GC. NAS messages are passed transparently through the RAN. The NAS layer 250 is used to manage the establishment of communication sessions and for maintaining continuous communications with the UE 205 as it moves between different cells of the RAN. In contrast, the AS layers 255 and 260 are between the UE 205 and the RAN (i.e., RAN node 210) and carry information over the wireless portion of the network. While not depicted in FIG. 2, the IP layer exists above the NAS layer 250, a transport layer exists above the IP layer, and an application layer exists above the transport layer.

The MAC sublayer 225 is the lowest sublayer in the L2 architecture of the NR protocol stack. Its connection to the PHY layer 220 below is through transport channels, and the connection to the RLC sublayer 230 above is through logical channels. The MAC sublayer 225 therefore performs multiplexing and demultiplexing between logical channels and transport channels: the MAC sublayer 225 in the transmitting side constructs MAC PDUs (also known as transport blocks (“TBs”)) from MAC Service Data Units (“SDUs”) received through logical channels, and the MAC sublayer 225 in the receiving side recovers MAC SDUs from MAC PDUs received through transport channels.

The MAC sublayer 225 provides a data transfer service for the RLC sublayer 230 through logical channels, which are either control logical channels which carry control data (e.g., RRC signaling) or traffic logical channels which carry user plane data. On the other hand, the data from the MAC sublayer 225 is exchanged with the PHY layer 220 through transport channels, which are classified as UL or DL. Data is multiplexed into transport channels depending on how it is transmitted over the air.

The PHY layer 220 is responsible for the actual transmission of data and control information via the air interface, i.e., the PHY layer 220 carries all information from the MAC transport channels over the air interface on the transmission side. Some of the important functions performed by the PHY layer 220 include coding and modulation, link adaptation (e.g., Adaptive Modulation and Coding (“AMC”)), power control, cell search and random access (for initial synchronization and handover purposes) and other measurements (inside the 3GPP system (i.e., NR and/or LTE system) and between systems) for the RRC layer 245. The PHY layer 220 performs transmissions based on transmission parameters, such as the modulation scheme, the coding rate (i.e., the modulation and coding scheme (“MCS”)), the number of PRBs, etc.

A U2N relay is a potential means to increase coverage of a serving cell, e.g., using one or multiple hops. For U2N coverage extension, Uu coverage reachability is necessary for UEs to reach a server in a PDN network or a counterpart UE out of proximity area. The U2N relay UE is an in-coverage implementation of the UE 205 that extends coverage of the RAN node 210. Via the U2N relay UE, the RAN node 210 is able to serve an otherwise out-of-coverage implementation of the UE 205, referred to as a U2N remote UE.

In some embodiments, the U2N relay UE acts as a L3 relay (also referred to as an IP relay). Here, communication between the RAN node 210 and the U2N remote UE via L3 relay goes through a Uu link between the RAN node 210 (e.g., a first interface) and the U2N relay UE, and a PC5 link (e.g., a second interface) between the U2N relay UE and the U2N remote UE. In such embodiments, the protocol stack of the U2N relay UE may include SDAP, RRC, PDCP, RLC, MAC and PHY layers which interact with corresponding layers at the RAN node 210 via the first interface (i.e., corresponding to the Uu link), and which also interact with corresponding layers at the U2N remote UE via the second interface (i.e., corresponding to the PC5 link).

In some embodiments, the U2N relay UE acts as a L2 relay. In certain embodiments, the U2N relay UE acting as a L2 relay performs relay function below the PDCP sublayer 235, such that the U2N relay UE does not perform PDCP, RRC and SDAP functions for the communications between the RAN node 210 and the U2N remote UE. In such embodiments, the protocol stack of the U2N relay UE may include RLC sublayer 230, MAC sublayer 225, and PHY layer 220 entities which interact with corresponding layers at the RAN node 210 via the first interface, and which interact with corresponding layers at the U2N remote UE via the second interface. However, for the PDCP sublayer 235, the SDAP sublayer 240, and the RRC layer 245, the link endpoints are between the RAN node 210 and the U2N remote UE.

In some embodiments, the U2N relay UE acts as a L1 relay (also referred to as an Amplify and Forward relay) with HARQ functionality. In certain embodiments, the protocol stack of the U2N relay UE may comprises the PHY layer 220 and a HARQ entity (i.e., of the MAC sublayer 225) which interact with corresponding layers at the RAN node 210 via the first interface, and which interact with corresponding layers at the U2N remote UE via the second interface. However, for the remaining layers, the link endpoints are between the RAN node 210 and the U2N remote UE.

Note that the above relay descriptions are exemplary, and the U2N relay UE is not limited to the above-described relay implementations. Thus, the U2N relay UE may implement different protocol stacks and/or link endpoints than those described above, according to the below described solutions.

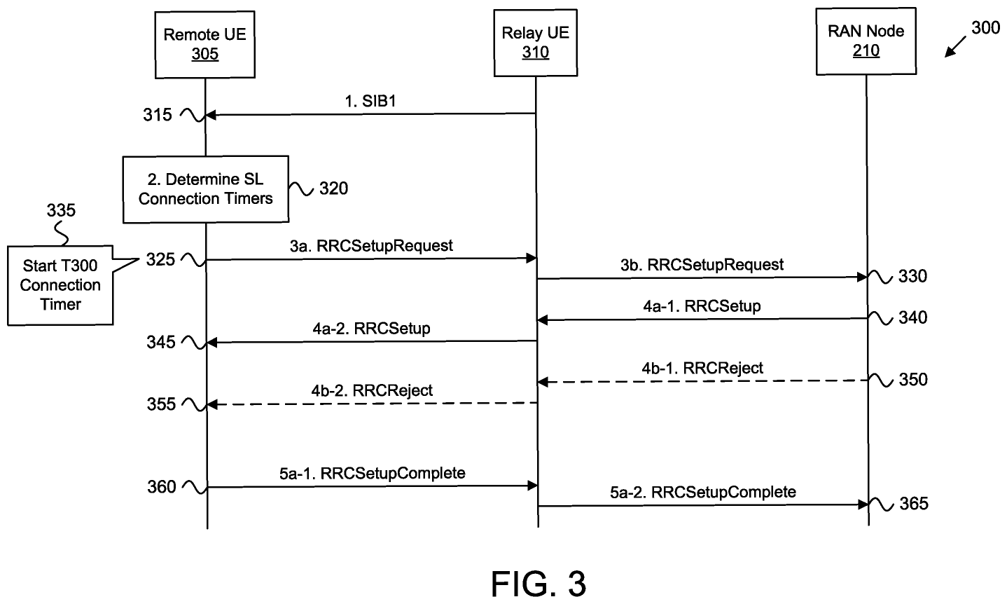

FIG. 3 depicts an exemplary procedure 300 for RRC connection establishment, according to embodiments of the disclosure. The procedure 300 involves a U2N sidelink Remote UE (i.e., denoted as “Remote UE”) 305 (e.g., an instance of an out-of-coverage remote unit 105 or out-of-coverage UE 205), a U2N sidelink relay UE (i.e., denoted as “Relay UE”) 310 (e.g., an instance of an in-coverage remote unit 105 or UE 205), and the RAN node 210 (e.g., an instance of the base unit 121). Via the procedure 300, the U2N sidelink Remote UE 305 is able to acquire SIB1 (and optionally other SIBs) and to initiate an RRC Connection Request with the RAN node 210 via the U2N sidelink Relay UE 310.

At Step 1, the U2N sidelink Remote UE 305 receives SIB1 via the U2N sidelink Relay UE 310 (see messaging 315). Optionally, the U2N sidelink Remote UE 305 may also receive one or more additional SIBs (denoted in FIG. 3 as “SIB_X”) via the U2N sidelink Relay UE 310. In various embodiments, the RAN node 210 broadcasts the SIB1 and the U2N sidelink Relay UE 310 relays the SIB1 to the U2N sidelink Remote UE 305. Here, it is assumed that SIB1 contains sidelink connection timer information, as described in greater detail below. In certain embodiments, the RAN node 210 may also broadcast one or more additional SIBs. In other embodiments, the one or more of the additional SIBs (i.e., SIB_X) may comprise on-demand SI, wherein the U2N sidelink Relay UE 310 may request and receive the additional SIB(s) from the RAN node 210 (not depicted in FIG. 3).

As used herein, “on-demand” SI refers to SI that is not periodically broadcast by the RAN (i.e., by RAN node 210). Instead, a requesting UE (e.g., the U2N sidelink Relay UE 310) must request specific SI from the RAN and the RAN (i.e., RAN node 210) then transmits the requested SI to the requesting UE (e.g., U2N sidelink Relay UE 310) in one or more SIBs.

At Step 2, the U2N sidelink Remote UE 305 determines the SL Connection Timers, e.g., based on the information in SIB1 (see block 320). Although FIG. 3 focuses primarily on RRC Connection establishment, the steps of receiving and/or determining SL Connection Timers applies to sidelink-specific versions of all three timers T300, T301 and T319—also referred as “SL Connection Timers.”

At Step 3a, the U2N sidelink Remote UE 305 sends a setup request message (e.g., RRCSetupRequest) to the U2N sidelink Relay UE 310 (see messaging 325). In certain embodiments, the U2N sidelink Remote UE 305 requests an RRC connection via the uplink shared channel (“UL-SCH”). In certain embodiments, the setup request message (e.g., RRCSetupRequest) includes an establishment cause parameter. At Step 3b, the U2N sidelink Relay UE 310 forwards the setup request message (i.e., RRCSetupRequest) to the RAN node 210 (see messaging 330).

Note that the U2N sidelink Remote UE 305 starts the sidelink-specific T300 connection timer when sending the setup request message (e.g., RRCSetupRequest) (see block 335). When the sidelink-specific T300 connection timer expires, the U2N sidelink Remote UE 305 takes actions as specified in section 5.3.3.7 of 3GPP TS 38.331 (v16.6.0), including informing upper layers about the failure to establish the RRC connection.

At Step 4a-1, the RAN node 210 sends a setup message (e.g., RRCSetup) to the U2N sidelink Relay UE 310 (see messaging 340). Here, the network establishes the SRBs and DRBs based on the establishment cause parameter. In certain embodiments, the setup message is sent via the downlink shared channel (“DL-SCH”). At Step 4a-2, the U2N sidelink Relay UE 310 forwards the setup message (e.g., RRCSetup) to the U2N sidelink Remote UE 305 (see messaging 345).

Alternatively, at Step 4b-1, the RAN node 210 sends a reject message (e.g., RRCReject) to the U2N sidelink Relay UE 310 (see messaging 350). At Step 4b-2, the U2N sidelink Relay UE 310 forwards the reject message (e.g., RRCReject) to the U2N sidelink Remote UE 305 (see messaging 355).

At Step 5a-1, the U2N sidelink Remote UE 305 acknowledges the setup message by sending a connection complete message (e.g., RRCSetupComplete) to the U2N sidelink Relay UE 310 (see messaging 360). At Step 5a-2, the U2N sidelink Relay UE 310 forwards the connection complete message (e.g., RRCSetupComplete) to the RAN node 210 (see messaging 365). The above described messages and their contents are described in greater detail in 3GPP TS 38.331 (v16.6.0), which document is incorporated herein by reference.

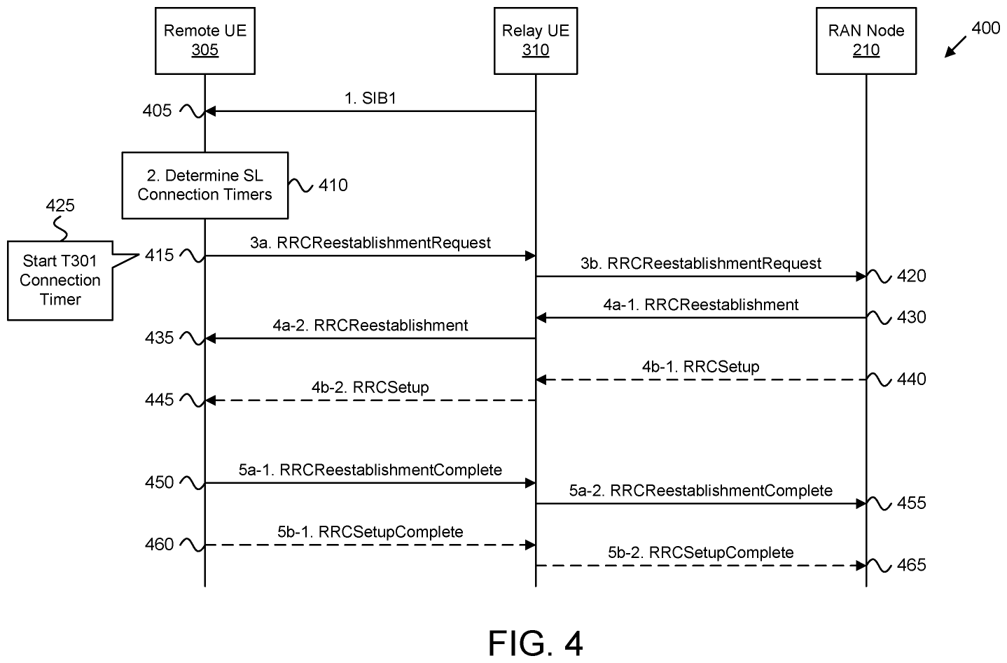

FIG. 4 depicts an exemplary procedure 400 for RRC connection reestablishment, according to embodiments of the disclosure. The procedure 400 involves the U2N sidelink Remote UE (i.e., denoted as “Remote UE”) 305, the U2N sidelink relay UE (i.e., denoted as “Relay UE”) 410, and the RAN node 210. Via the procedure 400, the U2N sidelink Remote UE 305 is able to acquire SIB1 (and optionally other SIBs) and to reestablish an RRC connection with the RAN node 210 via the U2N sidelink Relay UE 310. In various embodiments, the U2N sidelink Remote UE 305 initiates the procedure 400 for RRC connection reestablishment when one of the following conditions is met:
Upon detecting radio link failure: or
Upon handover failure: or
Upon mobility from E-UTRA failure: or
Upon integrity check failure indication from lower layers: or
Upon an RRC CONNECTION RECONFIGURATION failure.

At Step 1, the U2N sidelink Remote UE 305 receives SIB1 via the U2N sidelink Relay UE 310 (see messaging 405). Optionally, the U2N sidelink Remote UE 305 may also receive one or more additional SIBs (denoted in FIG. 4 as “SIB_X”) via the U2N sidelink Relay UE 310. In various embodiments, the RAN node 210 broadcasts the SIB1 and the U2N sidelink Relay UE 310 relays the SIB1 to the U2N sidelink Remote UE 305. Here, it is assumed that SIB1 contains sidelink connection timer information, as described in greater detail below. In certain embodiments, the RAN node 210 may also broadcast one or more additional SIBs. In other embodiments, the one or more of the additional SIBs (i.e., SIB_X) may comprise on-demand SI, wherein the U2N sidelink Relay UE 310 may request and receive the additional SIB(s) from the RAN node 210 (not depicted in FIG. 4).

At Step 2, the U2N sidelink Remote UE 305 determines the SL Connection Timers, e.g., based on the information in SIB1 (see block 410). Although FIG. 4 focuses primarily on RRC connection reestablishment, the steps of receiving and/or determining SL Connection Timers applies to sidelink-specific versions of all three timers T300, T301 and T319.

At Step 3a, the U2N sidelink Remote UE 305 sends a reestablishment request message (e.g., RRCReestablishmentRequest) to the U2N sidelink Relay UE 310 (see messaging 415). In certain embodiments, the U2N sidelink Remote UE 305 requests the reestablishment of an RRC connection via the UL-SCH. In certain embodiments, the reestablishment request message (e.g., RRCReestablishmentRequest) includes a reestablishment cause parameter. At Step 3b, the U2N sidelink Relay UE 310 forwards the reestablishment request message (i.e., RRCReestablishmentRequest) to the RAN node 210 (see messaging 420).

Note that the U2N sidelink Remote UE 305 starts the sidelink-specific T301 connection timer when sending the reestablishment request message (e.g., RRCReestablishmentRequest) (see block 425). When the sidelink-specific T301 connection timer expires, the U2N sidelink Remote UE 305 takes actions as specified in section 5.3.11 of 3GPP TS 38.331, including going to RRC_IDLE with release cause ‘RRC connection failure’.

At Step 4a-1, the RAN node 210 sends a reestablishment message (e.g., RRCReestablishment) to the U2N sidelink Relay UE 310 (see messaging 430). In some embodiments, the network reestablishes the SRBs and DRBs based on the reestablishment cause parameter. In certain embodiments, the reestablishment message is sent via the downlink shared channel (“DL-SCH”). At Step 4a-2, the U2N sidelink Relay UE 310 forwards the reestablishment message (e.g., RRCReestablishment) to the U2N sidelink Remote UE 305 (see messaging 435).

Alternatively, fallback to RRC establishment may be required in response to the reestablishment message. At Step 4b-1, the RAN node 210 sends a setup message (e.g., RRCSetup) to the U2N sidelink Relay UE 310 (see messaging 440). Here, the network establishes the SRBs and DRBs based on the reestablishment cause parameter. In certain embodiments, the setup message is sent via DL-SCH. At Step 4b-2, the U2N sidelink Relay UE 310 forwards the setup message (e.g., RRCSetup) to the U2N sidelink Remote UE 305 (see messaging 445).

At Step 5a-1, the U2N sidelink Remote UE 305 acknowledges the reestablishment message by sending a reestablishment complete message (e.g., RRCReestablishmentComplete) to the U2N sidelink Relay UE 310 (see messaging 450). At Step 5a-2, the U2N sidelink Relay UE 310 forwards the reestablishment complete message (e.g., RRCReestablishmentComplete) to the RAN node 210 (see messaging 455).

In the alternative where fallback to RRC establishment is required, at Step 5b-1, the U2N sidelink Remote UE 305 acknowledges the setup message by sending a connection complete message (e.g., RRCSetupComplete) to the U2N sidelink Relay UE 310 (see messaging 460). At Step 5b-2, the U2N sidelink Relay UE 310 forwards the connection complete message (e.g., RRCSetupComplete) to the RAN node 210 (see messaging 465). The above described messages and their contents are described in greater detail in 3GPP Technical Specification (“TS”) 38.331.

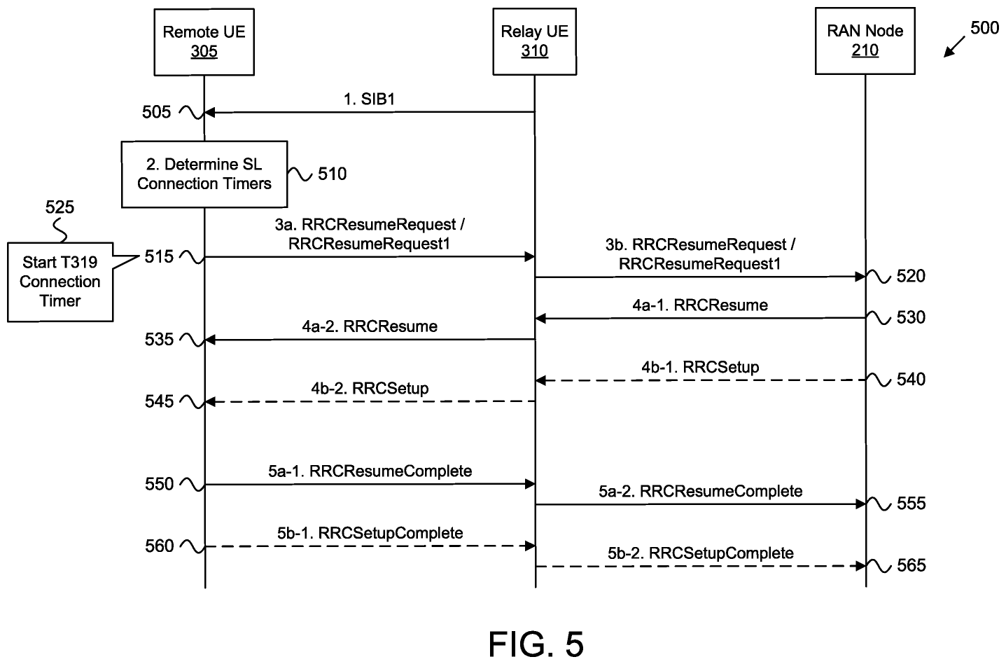

FIG. 5 depicts an exemplary procedure 500 for RRC connection resume, according to embodiments of the disclosure. The procedure 500 involves the U2N sidelink Remote UE (i.e., denoted as “Remote UE”) 305, the U2N sidelink relay UE (i.e., denoted as “Relay UE”) 510, and the RAN node 210. Via the procedure 500, the U2N sidelink Remote UE 305 is able to acquire SIB1 (and optionally other SIBs) and to resume a suspended RRC connection with the RAN node 210 via the U2N sidelink Relay UE 310. In various embodiments, the U2N sidelink Remote UE 305 initiates the procedure 500 when the upper layers or the AS layer requests the resumption of a suspended RRC connection (e.g., when responding to RAN paging or upon triggering RAN-based Notification Area updates while the U2N sidelink Remote UE 305 is in the RRC_INACTIVE state).

At Step 1, the U2N sidelink Remote UE 305 receives SIB1 via the U2N sidelink Relay UE 310 (see messaging 505). Optionally, the U2N sidelink Remote UE 305 may also receive one or more additional SIBs (denoted in FIG. 5 as “SIB_X”) via the U2N sidelink Relay UE 310. In various embodiments, the RAN node 210 broadcasts the SIB1 and the U2N sidelink Relay UE 310 relays the SIB1 to the U2N sidelink Remote UE 305. Here, it is assumed that SIB1 contains sidelink connection timer information, as described in greater detail below. In certain embodiments, the RAN node 210 may also broadcast one or more additional SIBs. In other embodiments, the one or more of the additional SIBs (i.e., SIB_X) may comprise on-demand SI, wherein the U2N sidelink Relay UE 310 may request and receive the additional SIB(s) from the RAN node 210 (not depicted in FIG. 5).

At Step 2, the U2N sidelink Remote UE 305 determines the SL Connection Timers, e.g., based on the information in SIB1 (see block 510). Although FIG. 5 focuses primarily on RRC connection resume, the steps of receiving and/or determining SL Connection Timers applies to sidelink-specific versions of all three timers T300, T301 and T319.

At Step 3a, the U2N sidelink Remote UE 305 sends a resume request message (e.g., RRCResumeRequest or RRCResumeRequest1) to the U2N sidelink Relay UE 310 (see messaging 515). In certain embodiments, the U2N sidelink Remote UE 305 requests to resume an RRC connection via the UL-SCH. In certain embodiments, the resume request message (e.g., RRCResumeRequest or RRCResumeRequest1) includes a resume cause parameter. At Step 3b, the U2N sidelink Relay UE 310 forwards the resume request message (i.e., RRCResumeRequest or RRCResumeRequest1) to the RAN node 210 (see messaging 520).

Note that the U2N sidelink Remote UE 305 starts the sidelink-specific T319 connection timer when sending the resume request message (e.g., RRCResumeRequest or RRCResumeRequest1) (see block 525). When the sidelink-specific T319 connection timer expires, the U2N sidelink Remote UE 305 takes actions as specified in section 5.3.13.5 of 3GPP TS 38.331, including going to RRC_IDLE with release cause ‘RRC connection failure’.

At Step 4a-1, the RAN node 210 sends a resume message (e.g., RRCResume) to the U2N sidelink Relay UE 310 (see messaging 530). In some embodiments, the network resumes the SRBs and DRBs based on the resume cause parameter. In certain embodiments, the resume message is sent via the downlink shared channel (“DL-SCH”). At Step 4a-2, the U2N sidelink Relay UE 310 forwards the resume message (e.g., RRCResume) to the U2N sidelink Remote UE 305 (see messaging 535).

Alternatively, fallback to RRC establishment may be required in response to the resume message. At Step 4b-1, the RAN node 210 sends a setup message (e.g., RRCSetup) to the U2N sidelink Relay UE 310 (see messaging 540). Here, the network establishes the SRBs and DRBs based on the resume cause parameter. In certain embodiments, the setup message is sent via DL-SCH. At Step 4b-2, the U2N sidelink Relay UE 310 forwards the setup message (e.g., RRCSetup) to the U2N sidelink Remote UE 305 (see messaging 545).

At Step 5a-1, the U2N sidelink Remote UE 305 acknowledges the resume message by sending a resume complete message (e.g., RRCResumeComplete) to the U2N sidelink Relay UE 310 (see messaging 550). At Step 5a-2, the U2N sidelink Relay UE 310 forwards the resume complete message (e.g., RRCResumeComplete) to the RAN node 210 (see messaging 555).

In the alternative where fallback to RRC establishment is required, at Step 5b-1, the U2N sidelink Remote UE 305 acknowledges the setup message by sending a connection complete message (e.g., RRCSetupComplete) to the U2N sidelink Relay UE 310 (see messaging 560). At Step 5b-2, the U2N sidelink Relay UE 310 forwards the connection complete message (e.g., RRCSetupComplete) to the RAN node 210 (see messaging 565). The above described messages and their contents are described in greater detail in 3GPP Technical Specification (“TS”) 38.331.

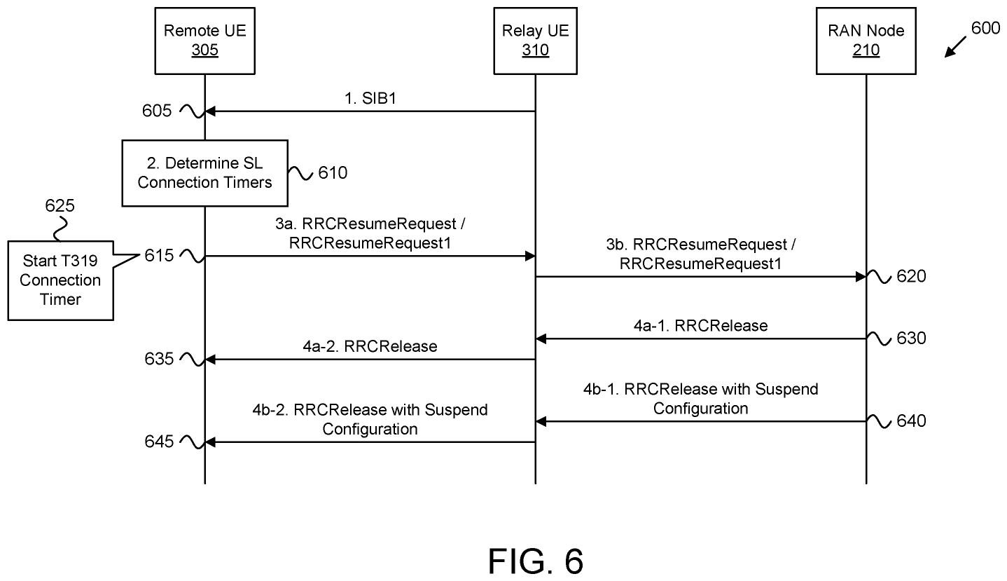

FIG. 6 depicts an exemplary procedure 600 for RRC connection resume followed by network-initiated release, according to embodiments of the disclosure. The procedure 600 involves the U2N sidelink Remote UE (i.e., denoted as “Remote UE”) 305, the U2N sidelink Relay UE (i.e., denoted as “Relay UE”) 310, and the RAN node 210. Via the procedure 600, the U2N sidelink U2N sidelink Remote UE 305 is able to acquire SIB1 (and optionally other SIBs) and request to resume a suspended RRC connection with the RAN node 210 via the U2N sidelink Relay UE 310. However, in the procedure 600 the network (i.e., the RAN node 210) initiates the RRC connection release procedure to transition the U2N sidelink U2N sidelink Remote UE 305 from a connected state (e.g., RRC_CONNECTED state) to a non-connected state (e.g., RRC_IDLE state). As discussed above, the U2N sidelink U2N sidelink Remote UE 305 may initiate the procedure when the upper layers or the AS layer requests the resumption of a suspended RRC connection.

At Step 1, the U2N sidelink U2N sidelink Remote UE 305 receives SIB1 via the U2N sidelink Relay UE 310 (see messaging 605). Optionally, the U2N sidelink U2N sidelink Remote UE 305 may also receive one or more additional SIBs (denoted in FIG. 6 as “SIB_X”) via the U2N sidelink Relay UE 310. In various embodiments, the RAN node 210 broadcasts the SIB1 and the U2N sidelink Relay UE 310 relays the SIB1 to the U2N sidelink U2N sidelink Remote UE 305. Here, it is assumed that SIB1 contains sidelink connection timer information, as described in greater detail below. In certain embodiments, the RAN node 210 may also broadcast one or more additional SIBs. In other embodiments, the one or more of the additional SIBs (i.e., SIB_X) may comprise on-demand SI, wherein the U2N sidelink Relay UE 310 may request and receive the additional SIB(s) from the RAN node 210 (not depicted in FIG. 6).

At Step 2, the U2N sidelink U2N sidelink Remote UE 305 determines the SL Connection Timers, e.g., based on the information in SIB1 (see block 610). Although FIG. 6 focuses primarily on RRC connection resume, the steps of receiving and/or determining SL Connection Timers applies to sidelink-specific versions of all three timers T300, T301 and T319.

At Step 3a, the U2N sidelink U2N sidelink Remote UE 305 sends a resume request message (e.g., RRCResumeRequest or RRCResumeRequest1) to the U2N sidelink Relay UE 310 (see messaging 615). In certain embodiments, the U2N sidelink U2N sidelink Remote UE 305 requests to resume an RRC connection via the UL-SCH. In certain embodiments, the resume request message (e.g., RRCResumeRequest or RRCResumeRequest1) includes a resume cause parameter. At Step 3b, the U2N sidelink Relay UE 310 forwards the resume request message (i.e., RRCResumeRequest or RRCResumeRequest1) to the RAN node 210 (see messaging 620).

Note that the U2N sidelink U2N sidelink Remote UE 305 starts the sidelink-specific T319 connection timer when sending the resume request message (e.g., RRCResumeRequest or RRCResumeRequest1) (see block 625). When the sidelink-specific T319 connection timer expires, the U2N sidelink U2N sidelink Remote UE 305 takes actions as specified in section 6.3.11 of 3GPP TS 38.331, including going to RRC_IDLE with release cause ‘RRC connection failure’.

At Step 4a-1, the RAN node 210 sends a release message (e.g., RRCRelease) to the U2N sidelink Relay UE 310 (see messaging 630). Here, the network releases the RRC connection and triggers the U2N sidelink U2N sidelink Remote UE 305 to transition from the connected state (e.g., RRC_CONNECTED state) to the idle state (e.g., RRC_IDLE state). At Step 4a-2, the U2N sidelink Relay UE 310 forwards the release message (e.g., RRCRelease) to the U2N sidelink U2N sidelink Remote UE 305 (see messaging 635).

Alternatively, at Step 4b-1, the RAN node 210 sends a release message (e.g., RRCRelease) to the U2N sidelink Relay UE 310 that contains a suspend configuration (see messaging 640). Here, the release message (e.g., RRCRelease with Suspend Configuration) suspends the RRC connection and triggers the U2N sidelink U2N sidelink Remote UE 305 to transition from the RRC_CONNECTED state to the RRC_IDLE state. At Step 4b-2, the U2N sidelink Relay UE 310 forwards the release message (e.g., RRCRelease) to the U2N sidelink U2N sidelink Remote UE 305 (see messaging 645). The above described messages and their contents are described in greater detail in 3GPP Technical Specification (“TS”) 38.331.

According to embodiments of a first solution, the SL Connection Timers are not signaled in SIB1, but are instead signaled in a different SIB which as an example could be SIB12 (which carriers NR sidelink communication configuration), SIB13 (which carries configurations of Vehicle-to-everything (“V2X”) sidelink communication defined in 3GPP TS 36.331, V2X communication encompasses both Vehicle-to-Vehicle (“V2V”) and Vehicle-to-Infrastructure (“V2I”)), SIB14 (which carries configurations of V2X sidelink communication defined in 3GPP TS 36.331, which can be used jointly with that included in SIB13), or a SIB containing other information required for U2N relay operation.

The connection Timers in the Uu context has following associated behavior, described in Table 1:

TABLE 1

| Timer | Start | Stop | At expiry |
|---|---|---|---|
| T300 | Upon transmission of | Upon reception of RRCSetup | Perform the actions as |
| | RRCSetupRequest. | or RRCReject message, cell | specified in 3GPP 38.331, |
| | | re-selection and upon | section 5.3.3.7. |
| | | abortion of connection | |
| | | establishment by upper | |
| | | layers. | |
| T301 | Upon transmission of | Upon reception of | Go to RRC_IDLE |
| | RRCReestablishmentRequest | RRCReestablishment or | |
| | | RRCSetup message as well as | |
| | | when the selected cell | |
| | | becomes unsuitable. | |
| T319 | Upon transmission of | Upon reception of | Perform the actions as |
| | RRCResumeRequest or | RRCResume, RRCSetup, | specified in 3GPP 38.331, |
| | RRCResumeRequest1. | RRCRelease, RRCRelease | section 5.3.13.5. |
| | | with suspendConfig or | |
| | | RRCReject message, cell re- | |
| | | selection and upon abortion | |
| | | of connection establishment | |
| | | by upper layers. | |

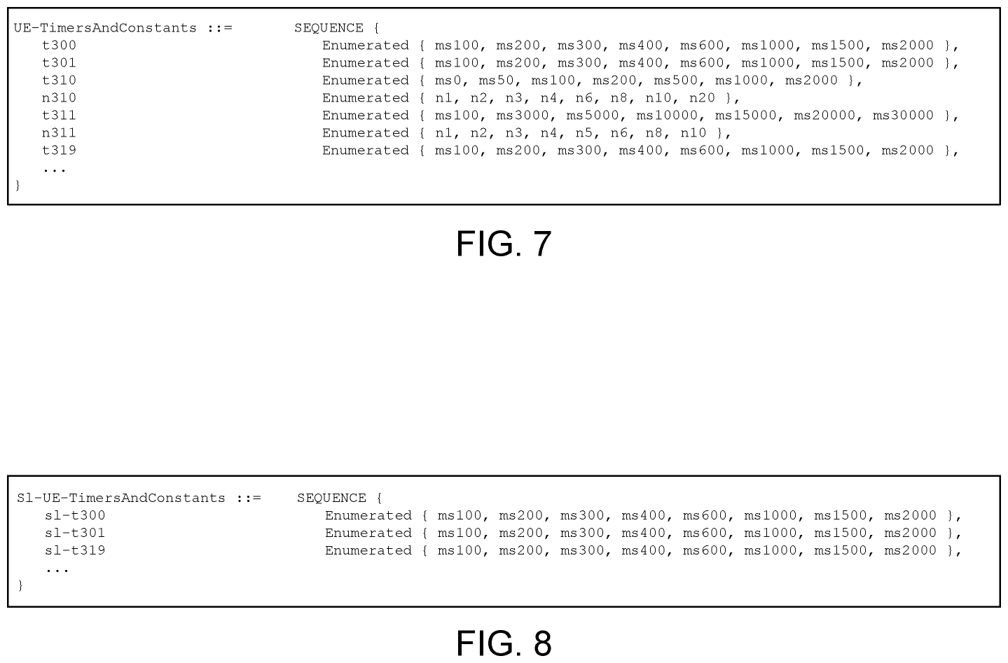

FIG. 7 depicts exemplary Abstract Syntax Notation 1 (“ASN.1”) representation of the ue-TimersAndConstants IE, according to embodiments of the disclosure. The Uu-specific Connection Timers are broadcasted in SIB1 in the IE called ue-TimersAndConstants which is depicted in FIG. 7. The SL Connection Timer in the sidelink context will have similar UE behavior even though the procedures will be executed using the U2N sidelink Relay UE 310 to reach the RAN node 210 in both UL and DL direction. As previously indicated, the Connection Timers required by a SL remote UE are T300, T301 and T319.

FIG. 8 depicts exemplary ASN.1 representation of an IE containing SL Connection Timers for the SL/PC5 interface, according to embodiments of the disclosure. In certain embodiments, these SL Connection Timers may be signaled in an additional SIB different than SIB1, e.g., SIB12, SIB13, SIB14, or another SIB containing information required for U2N relay operation. In one embodiment, the IE containing the connection timers (e.g., SL Connection Timers) and constants used by the U2N remote UE is called sl-UE-TimersAndConstants. In other embodiments, the IE containing the connection timers and constants used by the U2N remote UE for use by a sidelink remote UE (e.g., the U2N sidelink U2N sidelink Remote UE 305) may be called by another name. As previously indicated, the SL Connection Timers required by a SL remote UE includes a SL-specific T300, a SL-specific T301, and a SL-specific T319.

In one implementation of the first solution, the U2N sidelink Relay UE 310 extracts the SL Connection Timers (i.e., from the IE sl-UE-TimersAndConstants or similar IE) and forwards this information along with other SIB1 content to the U2N sidelink U2N sidelink Remote UE 305.

In another implementation of the first solution, the U2N sidelink Relay UE 310 forwards the corresponding SIB(s) to the U2N sidelink U2N sidelink Remote UE 305. In one embodiment, this is done before establishment of PC5 RRC Connection between the U2N sidelink U2N sidelink Remote UE 305 and the U2N sidelink Relay UE 310, e.g., in a Discovery message transmitted by the U2N sidelink Relay UE 310. In another embodiment, the U2N sidelink Relay UE 310 signals the SL Connection timers to the U2N sidelink U2N sidelink Remote UE 305 after PC5 RRC Connection is established, e.g., using a PC5 RRC reconfiguration message.

The first solution has the benefit that no additional load in SIB1 is necessary, and the U2N sidelink U2N sidelink Remote UE 305 can directly use the signaled values. In some embodiments, the SL Connections Timers signaled in the additional SIB may be incomplete, i.e., one or more of the SL-specific T300, the SL-specific T301, or the SL-specific T319 may be absent from the additional SIB. In such embodiments, the absent SL-specific timer may be derived from the corresponding Uu-specific Connection Timer. In one embodiment, the value of the Uu-specific Connection Timer is used as-is for the SL-specific timer whose value is missing from the additional SIB. In another embodiment, an offset is added to the value of the Uu-specific Connection Timer, as described in the second solution.

According to embodiments of a second solution, a sidelink remote UE (e.g., the U2N sidelink U2N sidelink Remote UE 305) can derive a SL Connection Timer value by receiving SIB1 (and thereby the IE ue-TimersAndConstants) and adding a fixed offset (e.g., 50 ms), referred to as “PC5-additional offset time,” to the corresponding Uu timer. In some embodiments, the extra delay on the PC5 interface is constant for all connection timers (T300, T301, T319 etc.). So, from a signaling perspective it is possible to just use this offset over the Uu-specific Connection Timers. In some embodiments, a timer-specific extra delay is signaled to the SL Remote UE, thereby each SL-specific Connection timer (e.g., SL-specific T300, SL-specific T301, and SL-specific T319) could have the same—or different—additional offset over the corresponding Uu-specific Connection Timers.

In one implementation of the second solution, the value for PC5-additional time offset is specified and therefore does not require any signaling. But to allow some flexibility to the network, to account for the local radio situation, congestion, Mode-1/Mode-2 resource allocation etc., in a second implementation, the PC5-additional time offset can be determined by the network and signaled in SIB1.

Thus, the method of SL Connection Timer derivation can minimize additional SIB1 signaling. In certain embodiments, the PC5 offset value is predetermined by specification such that there is no additional SIB1 signaling.

In some embodiments, the PC5-additional time offset can have limited values and signaling flexibility can be fulfilled with just 1, 2 or 3 bits. As examples, some potential values requiring just 1 bit could be ms20 (i.e., corresponding to 20 ms), ms50 (i.e., corresponding to 50 ms): other values can be added requiring more bits. In certain embodiments, the PC5-additional time offset can be signaled in SIB1, inside the ue-TimersAndConstants IE.

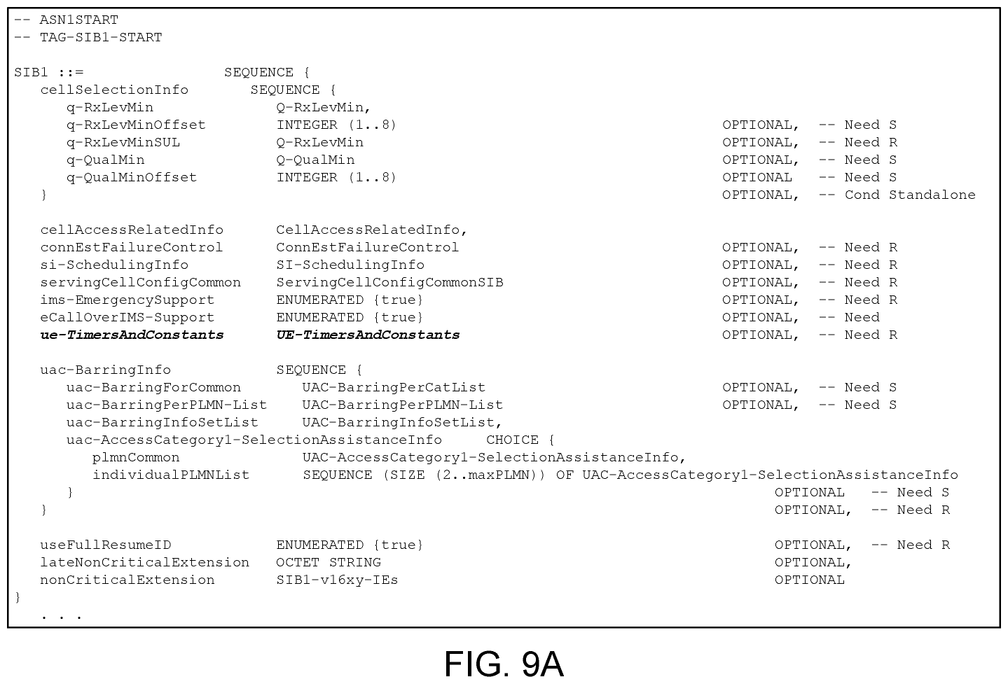

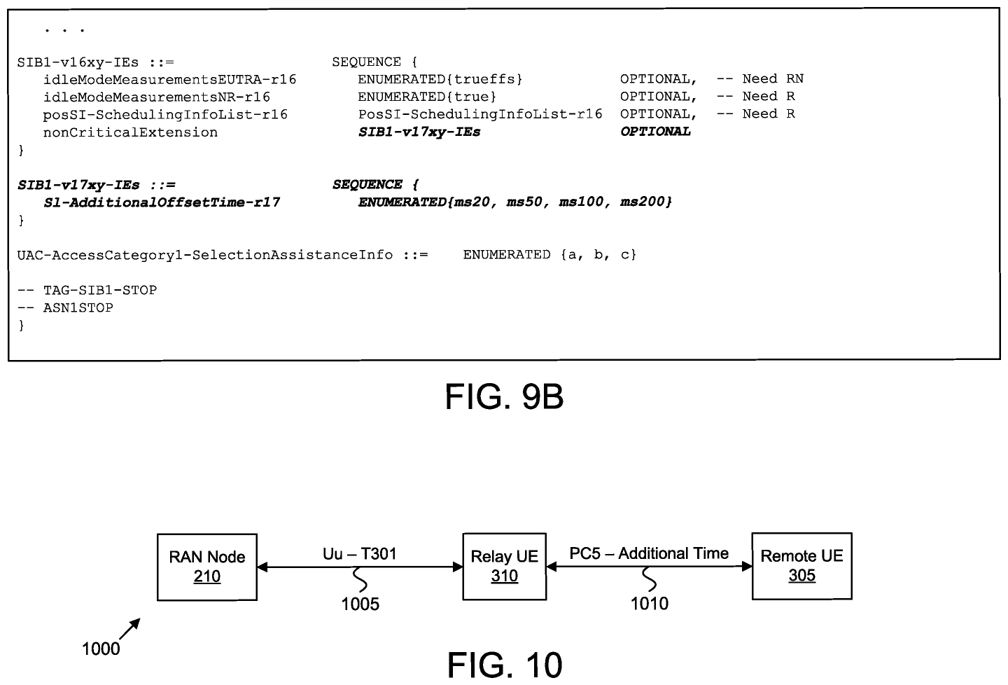

FIGS. 9A-9B depict an exemplary ASN.1 representation of SIB1 containing UE timers and constants for Uu interface and also additional time offset(s) for SL interface. In the depicted example, the additional time offset is signaled using 2 bits in SIB1.

At FIG. 9B, the parameter SI-AdditionalOffsetTimer-r17 uses 2 bits to indicate the value of the PC5-additional time offset from the exemplary set {20 ms, 50 ms, 100 ms, 200 ms}. In other embodiments, the PC5-additional time offset may be signaled outside at the main SIB1 level.

In another embodiment of the second solution, assuming the Connection Timers T300, T301 and T319 have values of 100, 200 and 300 ms respectively in received SIB1, and if the PC5-additional time offset is 50 ms, then the corresponding SL Connection timers will be:

$$SL - T 300 = 100 ms + 50 ms = 150 ms$$

$$SL - T 301 = 200 ms + 50 ms = 250 ms$$

$$SL - T 319 = 300 ms + 50 ms = 350 ms$$

In some embodiments, the network may calculate the time offset (PC5-additional time offset) as twice (UL and DL) the worst case time a PC5 RRC message (e.g., 80 bits) takes to get through successfully between the U2N sidelink U2N sidelink Remote UE 305 and its U2N sidelink Relay UE 310, e.g., with 3 PC5 re-transmissions in each direction or so. The worst case needs to be defined under certain radio condition and channel congestion (e.g., busyness ratio) on PC5 link and would depend on required connection establishment performance. The worst case may also depend on resource allocation mode (Mode 1 or Mode 2) for PC5 communication.

In one implementation, the sidelink U2N sidelink Remote UE 305 (i.e., U2N sidelink U2N sidelink Remote UE 305) starts the RRC Connection Timers like T300, T301 and T319 with a given offset, which is for example signaled in SI or fixed in specifications as outlined above. Here, the U2N sidelink U2N sidelink Remote UE 305 does not calculate new RRC timer values based on the signaled offset but reuses the originally signaled RRC timer values. In one specific implementation, U2N sidelink U2N sidelink Remote UE 305 starts a new timer with value set to the time offset value signaled in SI (as shown above). Upon expiry of the new timer, U2N sidelink U2N sidelink Remote UE 305 starts the associated RRC timer, e.g., T300, T301 or T319 depending on the case.

FIG. 10 depicts a sidelink relay arrangement 1000 between the U2N sidelink U2N sidelink Remote UE 305 (i.e., SL Remote UE), the U2N sidelink Relay UE 310, and the network (i.e., RAN node 210) and associated connection timers. The Uu Connection timers 1005, such as T301, are used for supervising connection procedures on the Uu link between RAN node 210 and U2N sidelink Relay UE 310. A “PC5-additional time” offset 1010 is required to account for additional delay between the U2N sidelink U2N sidelink Remote UE 305 (i.e., an out-of-coverage SL UE) and the U2N sidelink Relay UE 310. Because the original Uu Connection timers 1005 are still under network configuration, the SL Connection timer values to be used by the U2N sidelink U2N sidelink Remote UE 305 are still configurable, and therefore under the control of the serving RAN node 210.

According to embodiments of a third solution, instead of just one value for each of the SL Connection Timers, two values are used. The first of these two values is used when the U2N sidelink Relay UE 310 is used in both the UL direction and the DL direction, wherein the second value is used when the U2N sidelink Relay UE 310 is used in only in one of UL and DL directions and the other direction uses direct connection between the U2N sidelink U2N sidelink Remote UE 305 and the RAN node 210. In some embodiments, the two values of the SL Connection Timers are signaled to the U2N sidelink U2N sidelink Remote UE 305 in SIB1 or an additional SIB (e.g., SIB12, SIB13, SIB14, or another SIB containing information required for U2N relay operation)—as described in the embodiments of the first solution. In other embodiments, the two values of the SL Connection Timers are derived the Uu-specific Connection Timers and a PC5-additional time offset—as described in the embodiments of the second solution.

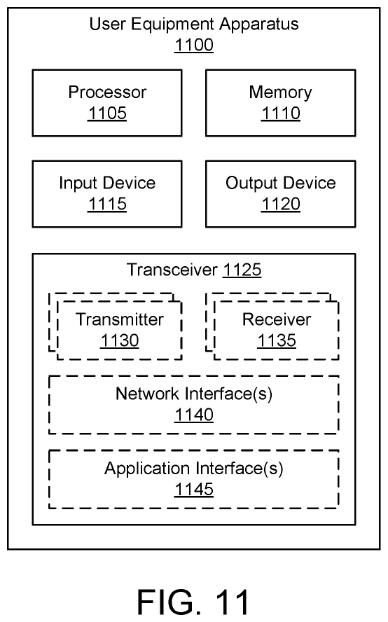

FIG. 11 depicts a user equipment apparatus 1100 that may be used for configuring sidelink connection timers, according to embodiments of the disclosure. In various embodiments, the user equipment apparatus 1100 is used to implement one or more of the solutions described above. The user equipment apparatus 1100 may be one embodiment of a user endpoint, such as the remote unit 105, the UE 205, the U2N sidelink U2N sidelink Remote UE 305, and/or the U2N sidelink Relay UE 310, as described above. Furthermore, the user equipment apparatus 1100 may include a processor 1105, a memory 1110, an input device 1115, an output device 1120, and a transceiver 1125.

In some embodiments, the input device 1115 and the output device 1120 are combined into a single device, such as a touchscreen. In certain embodiments, the user equipment apparatus 1100 may not include any input device 1115 and/or output device 1120. In various embodiments, the user equipment apparatus 1100 may include one or more of: the processor 1105, the memory 1110, and the transceiver 1125, and may not include the input device 1115 and/or the output device 1120.

As depicted, the transceiver 1125 includes at least one transmitter 1130 and at least one receiver 1135. In some embodiments, the transceiver 1125 communicates with one or more cells (or wireless coverage areas) supported by one or more base units 121. In various embodiments, the transceiver 1125 is operable on unlicensed spectrum. Moreover, the transceiver 1125 may include multiple UE panels supporting one or more beams. Additionally, the transceiver 1125 may support at least one network interface 1140 and/or application interface 1145. The application interface(s) 1145 may support one or more APIs. The network interface(s) 1140 may support 3GPP reference points, such as Uu, N1, PC5, etc. Other network interfaces 1140 may be supported, as understood by one of ordinary skill in the art.

The processor 1105, in one embodiment, may include any known controller capable of executing computer-readable instructions and/or capable of performing logical operations. For example, the processor 1105 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 1105 executes instructions stored in the memory 1110 to perform the methods and routines described herein. The processor 1105 is communicatively coupled to the memory 1110, the input device 1115, the output device 1120, and the transceiver 1125.

In various embodiments, the processor 1105 controls the user equipment apparatus 1100 to implement the above-described UE behaviors. In certain embodiments, the processor 1105 may include an application processor (also known as “main processor”) which manages application-domain and operating system (“OS”) functions and a baseband processor (also known as “baseband radio processor”) which manages radio functions.

In various embodiments, via the transceiver 1125, the processor 1105 receives a set of connection timers (e.g., UE-TimersAndConstants IE) from a primary system information block (e.g., SIB1) transmission of a serving node, and receives a first set of (i.e., one or more) sidelink connection timers (e.g., sl-UE-TimersAndConstants or UE-TimersAndConstantsRemoteUE IE) from an additional system information block (e.g., SIB12, SIB13, SIB14, or another SIB containing information required for U2N relay operation) of the serving node.

The processor 1105 determines a second set of sidelink connection timers for communication establishment with a network node (e.g., gNB) using a U2N sidelink relay UE, where respective values of the second set of sidelink connection timers are determined based at least in part on the first set of sidelink connection timers. Additionally, the processor 1105 uses a respective connection timer to supervise communication establishment with the network node via the U2N sidelink relay UE.

In some embodiments, the supervised communication establishment includes one of: a RRC Connection Establishment procedure, a RRC Connection Resume procedure, or a RRC Connection Reestablishment procedure. In some embodiments, the processor 1105 initiates the respective connection timer in response to the transceiver 1125 transmitting a RRC Connection Request, a RRC Resume Request, or a RRC Connection Reestablishment Request.

In some embodiments, the network node with which the communication establishment is initiated comprises a current serving node or non-serving network node. In some embodiments, the second set of sidelink connection timers for communication establishment comprises (i.e., SL-specific) timers ‘T300,’ ‘T301,’ and ‘T319’.

In some embodiments, at least one respective value of the second set of sidelink connection timers is determined based on the set of connection timers (e.g., contained in UE-TimersAndConstants IE) from the primary system information block (e.g., SIB1).

In some embodiments, the processor 1105 determines the respective values of the second set of sidelink connection timers by using a corresponding timer values of the first set of sidelink connection timers, if included in the additional system information block. Otherwise, in response to the corresponding timer value of being absent from the received first set of sidelink connection timers, the processor 1105 determines the missing value by using a timer value of an equivalent Uu connection timer from the primary system information block (e.g., SIB1).

In some embodiments, the primary system information block (e.g., SIB1) comprises a UE-TimersAndConstants information element that indicates the set of connection timers, and the additional system information block comprises a set of connection timers UE-TimersAndConstantsRemoteUE information element that indicates the first set of sidelink connection timers, where the additional system information block is different than the primary system information block (e.g., SIB1).

In some embodiments, the processor 1105 controls the transceiver 1125 to establish a sidelink (i.e., PC5) RRC connection with the U2N sidelink relay UE, where SI comprising at least the primary system information block (e.g., SIB1) is received in a discovery message received from the U2N sidelink relay UE prior to the establishment of the sidelink RRC connection.

In some embodiments, the processor 1105 controls the transceiver 1125 to establish a sidelink (i.e., PC5) RRC connection with the U2N sidelink relay UE, where SI comprising at least the primary system information block (e.g., SIB1) is received in a RRC reconfiguration message received from the U2N sidelink relay UE after the establishment of the sidelink RRC connection.

The memory 1110, in one embodiment, is a computer readable storage medium. In some embodiments, the memory 1110 includes volatile computer storage media. For example, the memory 1110 may include a RAM, including dynamic RAM (“DRAM”), synchronous dynamic RAM (“SDRAM”), and/or static RAM (“SRAM”). In some embodiments, the memory 1110 includes non-volatile computer storage media. For example, the memory 1110 may include a hard disk drive, a flash memory, or any other suitable non-volatile computer storage device. In some embodiments, the memory 1110 includes both volatile and non-volatile computer storage media.

In some embodiments, the memory 1110 stores data related to configuring sidelink connection timers. For example, the memory 1110 may store parameters, configurations, and the like as described above. In certain embodiments, the memory 1110 also stores program code and related data, such as an operating system or other controller algorithms operating on the user equipment apparatus 1100.

The input device 1115, in one embodiment, may include any known computer input device including a touch panel, a button, a keyboard, a stylus, a microphone, or the like. In some embodiments, the input device 1115 may be integrated with the output device 1120, for example, as a touchscreen or similar touch-sensitive display. In some embodiments, the input device 1115 includes a touchscreen such that text may be input using a virtual keyboard displayed on the touchscreen and/or by handwriting on the touchscreen. In some embodiments, the input device 1115 includes two or more different devices, such as a keyboard and a touch panel.

The output device 1120, in one embodiment, is designed to output visual, audible, and/or haptic signals. In some embodiments, the output device 1120 includes an electronically controllable display or display device capable of outputting visual data to a user. For example, the output device 1120 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 1120 may include a wearable display separate from, but communicatively coupled to, the rest of the user equipment apparatus 1100, such as a smart watch, smart glasses, a heads-up display, or the like. Further, the output device 1120 may be a component of a smart phone, a personal digital assistant, a television, a table computer, a notebook (laptop) computer, a personal computer, a vehicle dashboard, or the like.

In certain embodiments, the output device 1120 includes one or more speakers for producing sound. For example, the output device 1120 may produce an audible alert or notification (e.g., a beep or chime). In some embodiments, the output device 1120 includes one or more haptic devices for producing vibrations, motion, or other haptic feedback. In some embodiments, all or portions of the output device 1120 may be integrated with the input device 1115. For example, the input device 1115 and output device 1120 may form a touchscreen or similar touch-sensitive display. In other embodiments, the output device 1120 may be located near the input device 1115.

The transceiver 1125 communicates with one or more network functions of a mobile communication network via one or more access networks. The transceiver 1125 operates under the control of the processor 1105 to transmit messages, data, and other signals and also to receive messages, data, and other signals. For example, the processor 1105 may selectively activate the transceiver 1125 (or portions thereof) at particular times in order to send and receive messages.

The transceiver 1125 includes at least one transmitter 1130 and at least one receiver 1135. One or more transmitters 1130 may be used to provide UL communication signals to a base unit 121, such as the UL transmissions described herein. Similarly, one or more receivers 1135 may be used to receive DL communication signals from the base unit 121, as described herein. Although only one transmitter 1130 and one receiver 1135 are illustrated, the user equipment apparatus 1100 may have any suitable number of transmitters 1130 and receivers 1135. Further, the transmitter(s) 1130 and the receiver(s) 1135 may be any suitable type of transmitters and receivers. In one embodiment, the transceiver 1125 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example, a single chip performing functions for use with both licensed and unlicensed radio spectrum. In some embodiments, the first transmitter/receiver pair and the second transmitter/receiver pair may share one or more hardware components. For example, certain transceivers 1125, transmitters 1130, and receivers 1135 may be implemented as physically separate components that access a shared hardware resource and/or software resource, such as for example, the network interface 1140.

In various embodiments, one or more transmitters 1130 and/or one or more receivers 1135 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 1130 and/or one or more receivers 1135 may be implemented and/or integrated into a multi-chip module. In some embodiments, other components such as the network interface 1140 or other hardware components/circuits may be integrated with any number of transmitters 1130 and/or receivers 1135 into a single chip. In such embodiment, the transmitters 1130 and receivers 1135 may be logically configured as a transceiver 1125 that uses one or more common control signals or as modular transmitters 1130 and receivers 1135 implemented in the same hardware chip or in a multi-chip module.

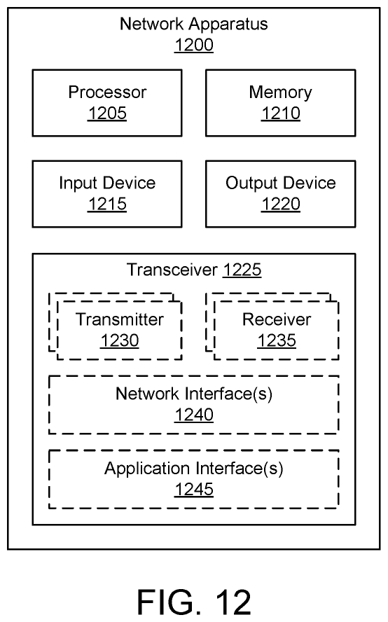

FIG. 12 depicts a network apparatus 1200 that may be used for configuring sidelink connection timers, according to embodiments of the disclosure. In one embodiment, the network apparatus 1200 may be one implementation of a network endpoint, such as the base unit 121 and/or RAN node 210, as described above. Furthermore, the network apparatus 1200 may include a processor 1205, a memory 1210, an input device 1215, an output device 1220, and a transceiver 1225.

In some embodiments, the input device 1215 and the output device 1220 are combined into a single device, such as a touchscreen. In certain embodiments, the network apparatus 1200 may not include any input device 1215 and/or output device 1220. In various embodiments, the network apparatus 1200 may include one or more of: the processor 1205, the memory 1210, and the transceiver 1225, and may not include the input device 1215 and/or the output device 1220.

As depicted, the transceiver 1225 includes at least one transmitter 1230 and at least one receiver 1235. Here, the transceiver 1225 communicates with one or more remote units 105. Additionally, the transceiver 1225 may support at least one network interface 1240 and/or application interface 1245. The application interface(s) 1245 may support one or more APIs. The network interface(s) 1240 may support 3GPP reference points, such as Uu, N1, N2 and N3. Other network interfaces 1240 may be supported, as understood by one of ordinary skill in the art.

The processor 1205, in one embodiment, may include any known controller capable of executing computer-readable instructions and/or capable of performing logical operations. For example, the processor 1205 may be a microcontroller, a microprocessor, a CPU, a GPU, an auxiliary processing unit, a FPGA, or similar programmable controller. In some embodiments, the processor 1205 executes instructions stored in the memory 1210 to perform the methods and routines described herein. The processor 1205 is communicatively coupled to the memory 1210, the input device 1215, the output device 1220, and the transceiver 1225.

In various embodiments, the network apparatus 1200 is a RAN node (e.g., gNB) that communicates with one or more UEs, as described herein. In such embodiments, the processor 1205 controls the network apparatus 1200 to perform the above-described RAN behaviors. When operating as a RAN node, the processor 1205 may include an application processor (also known as “main processor”) which manages application-domain and operating system (“OS”) functions and a baseband processor (also known as “baseband radio processor”) which manages radio functions.

In various embodiments, the processor 1205 identifies a set of SL-specific connection timers and, via the transceiver 1225, transmits information of the same to at least one UE. For example, the apparatus 1200 may transmit Uu-specific connection timers in SIB1 and additionally transmit the SL-specific connection timers in an additional SIB. As another example, the apparatus 1200 may broadcast a time-offset for use in deriving the SL-specific connection timers from the Uu-specific connection timers.

In some embodiments, the time-offset includes a time value in milliseconds to be used for supervising a RRC Connection Establishment procedure by a remote UE in sidelink communication. In some embodiments, the time-offset includes a time value in milliseconds to be used for supervising a RRC Connection Resume procedure by a remote UE in sidelink communication. In some embodiments, the time-offset includes a time value in milliseconds to be used for supervising a RRC Connection Reestablishment procedure by a remote UE in sidelink communication.

The memory 1210, in one embodiment, is a computer readable storage medium. In some embodiments, the memory 1210 includes volatile computer storage media. For example, the memory 1210 may include a RAM, including DRAM, SDRAM, and/or SRAM. In some embodiments, the memory 1210 includes non-volatile computer storage media. For example, the memory 1210 may include a hard disk drive, a flash memory, or any other suitable non-volatile computer storage device. In some embodiments, the memory 1210 includes both volatile and non-volatile computer storage media.

In some embodiments, the memory 1210 stores data related to configuring sidelink connection timers. For example, the memory 1210 may store parameters, configurations, and the like, as described above. In certain embodiments, the memory 1210 also stores program code and related data, such as an operating system or other controller algorithms operating on the network apparatus 1200.

The input device 1215, in one embodiment, may include any known computer input device including a touch panel, a button, a keyboard, a stylus, a microphone, or the like. In some embodiments, the input device 1215 may be integrated with the output device 1220, for example, as a touchscreen or similar touch-sensitive display. In some embodiments, the input device 1215 includes a touchscreen such that text may be input using a virtual keyboard displayed on the touchscreen and/or by handwriting on the touchscreen. In some embodiments, the input device 1215 includes two or more different devices, such as a keyboard and a touch panel.

The output device 1220, in one embodiment, is designed to output visual, audible, and/or haptic signals. In some embodiments, the output device 1220 includes an electronically controllable display or display device capable of outputting visual data to a user. For example, the output device 1220 may include, but is not limited to, an LCD display, an LED display, an OLED display, a projector, or similar display device capable of outputting images, text, or the like to a user. As another, non-limiting, example, the output device 1220 may include a wearable display separate from, but communicatively coupled to, the rest of the network apparatus 1200, such as a smart watch, smart glasses, a heads-up display, or the like. Further, the output device 1220 may be a component of a smart phone, a personal digital assistant, a television, a table computer, a notebook (laptop) computer, a personal computer, a vehicle dashboard, or the like.

In certain embodiments, the output device 1220 includes one or more speakers for producing sound. For example, the output device 1220 may produce an audible alert or notification (e.g., a beep or chime). In some embodiments, the output device 1220 includes one or more haptic devices for producing vibrations, motion, or other haptic feedback. In some embodiments, all or portions of the output device 1220 may be integrated with the input device 1215. For example, the input device 1215 and output device 1220 may form a touchscreen or similar touch-sensitive display. In other embodiments, the output device 1220 may be located near the input device 1215.

The transceiver 1225 includes at least one transmitter 1230 and at least one receiver 1235. One or more transmitters 1230 may be used to communicate with the UE, as described herein. Similarly, one or more receivers 1235 may be used to communicate with network functions in the PLMN and/or RAN, as described herein. Although only one transmitter 1230 and one receiver 1235 are illustrated, the network apparatus 1200 may have any suitable number of transmitters 1230 and receivers 1235. Further, the transmitter(s) 1230 and the receiver(s) 1235 may be any suitable type of transmitters and receivers.

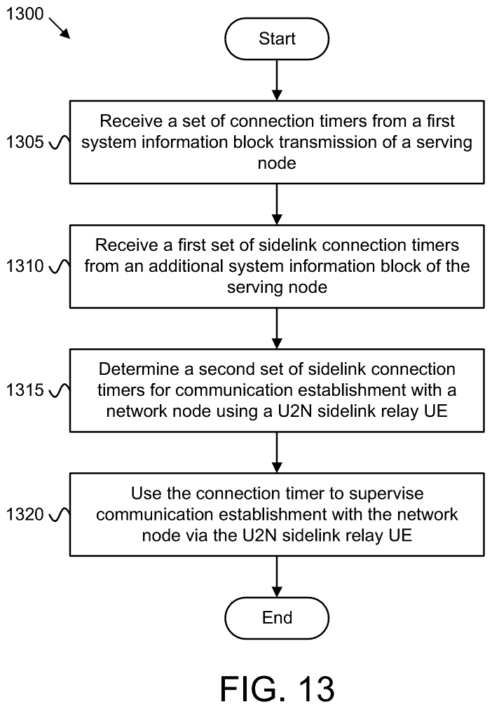

FIG. 13 depicts one embodiment of a method 1300 for configuring sidelink connection timers, according to embodiments of the disclosure. In various embodiments, the method 1300 is performed by a communication device, such as a remote unit 105, a UE 205, and/or the user equipment apparatus 1100, as described above. In some embodiments, the method 1300 is performed by a processor, such as a microcontroller, a microprocessor, a CPU, a GPU, an auxiliary processing unit, a FPGA, or the like.

The method 1300 includes receiving 1305 a set of connection timers (e.g., UE-TimersAndConstants IE) from a first system information block (i.e., SIB1) transmission of a serving node. The method 1300 includes receiving 1310 a first set of (i.e., one or more) sidelink connection timers (e.g., sl-UE-TimersAndConstants IE) from an additional system information block of the serving node. The method 1300 includes determining 1315 a second set of sidelink connection timers for communication establishment with a network node using a UE-to-Network sidelink relay UE, where a respective value for each timer in the second set of sidelink connection timers is determined based at least in part on the first set of sidelink connection timers. The method 1300 includes using 1320 a respective connection timer to supervise communication establishment with the network node via the U2N sidelink relay UE.

Disclosed herein is a first apparatus for configuring sidelink connection timers, according to embodiments of the disclosure. The first apparatus may be implemented by a communication device, such as a remote unit 105, a UE 205, the U2N sidelink U2N sidelink Remote UE 305, and/or the user equipment apparatus 1100, as described above. The first apparatus includes a processor coupled to a memory, the processor configured to cause the apparatus to: A) receive a set of connection timers (e.g., UE-TimersAndConstants IE) from a first system information block (i.e., SIB1) transmission of a serving node: B) receive a first set of (i.e., one or more) sidelink connection timers (e.g., sl-UE-TimersAndConstants or UE-TimersAndConstantsRemoteUJE IE) from an additional system information block of the serving node: C) determine a second set of sidelink connection timers for communication establishment with a network node using a U2N sidelink relay UE, where respective values of the second set of sidelink connection timers are determined based at least in part on the first set of sidelink connection timers; and D) use a respective connection timer to supervise communication establishment with the network node via the U2N sidelink relay UE.

In some embodiments, the supervised communication establishment includes one of: a RRC Connection Establishment procedure, a RRC Connection Resume procedure, or a RRC Connection Reestablishment procedure. In some embodiments, the processor is configured to cause the apparatus to initiate the respective connection timer in response to transmitting a RRC Connection Request, a RRC Resume Request, or a RRC Connection Reestablishment Request.

In some embodiments, the network node with which the communication establishment is initiated comprises a current serving node or non-serving network node. In some embodiments, the second set of sidelink connection timers for communication establishment comprises (i.e., SL-specific) timers ‘T300,’ ‘T301,’ and ‘T319’.

In some embodiments, at least one respective value of the second set of sidelink connection timers is determined based on the set of connection timers (e.g., contained in UE-TimersAndConstants IE) from the first system information block (i.e., SIB1).

In some embodiments, the processor is configured to cause the apparatus to determine the respective values of the second set of sidelink connection timers by using a corresponding timer values of the first set of sidelink connection timers if included in the additional system information block and otherwise using a timer value of an equivalent Uu connection timer from the first system information block (e.g., in response to the corresponding timer value of being absent from the received first set of sidelink connection timers).

In some embodiments, the first system information block (i.e., SIB1) comprises a UE-TimersAndConstants information element that indicates the set of connection timers, and the additional system information block comprises a set of connection timers UE-TimersAndConstantsRemoteUE information element that indicates the first set of sidelink connection timers, where the additional system information block is different than the first system information block (i.e., SIB1).

In some embodiments, the processor is configured to cause the apparatus to establish a sidelink (i.e., PC5) RRC connection with the U2N sidelink relay UE, where SI comprising at least the first system information block (i.e., SIB1) is received in a discovery message received from the U2N sidelink relay UE prior to the establishment of the sidelink RRC connection.

In some embodiments, the processor is configured to cause the apparatus to establish a sidelink (i.e., PC5) RRC connection with the U2N sidelink relay UE, where SI comprising at least the first system information block (i.e., SIB1) is received in a RRC reconfiguration message received from the U2N sidelink relay UE after the establishment of the sidelink RRC connection.

Disclosed herein is a first method for configuring sidelink connection timers, according to embodiments of the disclosure. The first method may be performed by a communication device, such as a remote unit 105, a UE 205, the U2N sidelink U2N sidelink Remote UE 305, and/or the user equipment apparatus 1100, as described above. The first method includes receiving a set of connection timers (e.g., UE-TimersAndConstants IE) from a first system information block (i.e., SIB1) transmission of a serving node and receiving a first set of (i.e., one or more) sidelink connection timers (e.g., sl-UE-TimersAndConstants IE) from an additional system information block of the serving node. The first method includes determining a second set of sidelink connection timers for communication establishment with a network node using a UE-to-Network sidelink relay UE, where a respective value for each timer in the second set of sidelink connection timers is determined based at least in part on the first set of sidelink connection timers. The first method includes using a respective connection timer to supervise communication establishment with the network node via the U2N sidelink relay UE.

In some embodiments, the supervised communication establishment includes one of: a RRC Connection Establishment procedure, a RRC Connection Resume procedure, or a RRC Connection Reestablishment procedure. In some embodiments, the first method includes initiating the respective connection timer in response to transmitting a RRC Connection Request, a RRC Resume Request, or a RRC Connection Reestablishment Request.

In some embodiments, the network node with which the communication establishment is initiated comprises a current serving node or non-serving network node. In some embodiments, the second set of sidelink connection timers for communication establishment comprises (e.g., SL-specific) timers ‘T300,’ ‘T301,’ and ‘T319’.

In some embodiments, at least one respective value of the second set of sidelink connection timers is determined based on the set of connection timers (e.g., contained in UE-TimersAndConstants IE) from the first system information block (i.e., SIB1).

In some embodiments, the first method includes determining the respective values of the second set of sidelink connection timers by using a corresponding timer values of the first set of sidelink connection timers if included in the additional system information block and otherwise using a timer value of an equivalent Uu connection timer from the first system information block (e.g., in response to the corresponding timer value of being absent from the received first set of sidelink connection timers).

In some embodiments, the first system information block (i.e., SIB1) comprises a UE-TimersAndConstants IE that indicates the set of connection timers, and the additional system information block comprises a set of connection timers (i.e., sl-UE-TimersAndConstants or UE-TimersAndConstantsRemoteUJE) information element that indicates the first set of sidelink connection timers, where the additional system information block is different than the first system information block (i.e., SIB1).

In some embodiments, the first method includes establishing a sidelink (i.e., PC5) RRC connection with the U2N sidelink relay UE, where SI comprising at least the first system information block (i.e., SIB1) is received in a discovery message received from the U2N sidelink relay UE prior to the establishment of the sidelink RRC connection.

In some embodiments, the first method includes establishing a sidelink (i.e., PC5) RRC connection with the U2N sidelink relay UE, where SI comprising at least the first system information block (i.e., SIB1) is received in a RRC reconfiguration message received from the U2N sidelink relay UE after the establishment of the sidelink RRC connection.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A User Equipment (“UE”) for wireless communication, comprising:
at least one memory; and
at least one processor coupled with the at least one memory and configured to cause the UE to:
receive a set of connection timers from a first system information block (“SIB1”) of a serving node;
receive a first set of sidelink (“SL”) connection timers from an additional system information block (“SIB”) of the serving node;
determine a second set of SL connection timers for communication establishment with a base station using a UE-to-Network (“U2N”) SL relay UE,
wherein respective values of the second set of SL connection timers are determined based at least in part on the first set of SL connection timers; and
use a respective connection timer to supervise communication establishment with the base station via the U2N SL relay UE.

2. The UE of claim 1, wherein the supervised communication establishment includes one of: a Radio Resource Control (“RRC”) Connection Establishment procedure, a RRC Connection Resume procedure, or a RRC Connection Reestablishment procedure.

3. The UE of claim 1, wherein the at least one processor is configured to cause the UE to initiate the respective connection timer in response to transmitting a Radio Resource Control (“RRC”) Connection Request, a RRC Resume Request, or a RRC Connection Reestablishment Request.

4. The UE of claim 1, wherein the base station comprises the serving node or a non-serving base station.

5. The UE of claim 1, wherein the at least one processor is configured to cause the UE to determine at least one respective value of the second set of SL connection timers based on the set of connection timers from the SIB1.

6. The UE of claim 1, wherein the at least one processor is configured to cause the UE to determine the respective values of the second set of SL connection timers by using based on a corresponding timer values of the first set of SL connection timers if included in the additional SIB and otherwise based on a timer value of an equivalent Uu connection timer from the SIB1.

7. The UE of claim 1, wherein the second set of SL connection timers for communication establishment comprises timers ‘T300,’ ‘T301,’ and ‘T319.’

8. The UE of claim 1, wherein the SIB1 comprises a UE-TimersAndConstants information element (IE) that indicates the set of connection timers, wherein the additional SIB comprises a set of connection timers UE-TimersAndConstantsRemote UE IE that indicates the first set of SL connection timers, wherein the additional SIB is different than the SIB1.

9. The UE of claim 1, wherein the at least one processor is configured to cause the UE to establish a SL Radio Resource Control (“RRC”) connection with the U2N SL relay UE, wherein system information comprising at least the SIB1 is received in a discovery message received from the U2N SL relay UE prior to the establishment of the SL RRC connection.

10. The UE of claim 1, wherein the at least one processor is configured to cause the UE to establish a SL Radio Resource Control (“RRC”) connection with the U2N SL relay UE, wherein system information comprising at least the SIB1 is received in a RRC reconfiguration message received from the U2N SL relay UE after the establishment of the SL RRC connection.

11. A processor for wireless communication, comprising:
at least one controller coupled with at least one memory and configured to cause the processor to:
receive a set of connection timers from a first system information block (“SIB”) of a serving node;
receive a first set of sidelink (“SL”) connection timers from an additional SIB of the serving node;
determine a second set of SL connection timers for communication establishment with a base station using a UE-to-Network (“U2N”) SL relay UE,
wherein a respective value for each timer in the second set of SL connection timers is determined based at least in part on the first set of SL connection timers; and
use a respective connection timer to supervise communication establishment with the base station via the U2N SL relay UE.

12. The processor of claim 11, wherein the supervised communication establishment includes one of: a Radio Resource Control (“RRC”) Connection Establishment procedure, a RRC Connection Resume procedure, or a RRC Connection Reestablishment procedure.

13. The processor of claim 11, wherein the at least one controller is configured to cause the processor to initiate further comprising initiating the respective connection timer in response to transmitting a Radio Resource Control (“RRC”) Connection Request, a RRC Resume Request, or a RRC Connection Reestablishment Request.

14. The processor of claim 11, wherein the at least one controller is configured to cause the processor to determine at least one respective value of the second set of SL connection timers based on the set of connection timers from the SIB1.

15. The processor of claim 11, wherein the at least one controller is configured to cause the processor to determine the respective values of the second set of SL connection timers based on a corresponding timer values of the first set of SL connection timers if included in the additional SIB and otherwise based on a timer value of an equivalent Uu connection timer from the SIB1.

16. The processor of claim 11, wherein the base station comprises the serving node or a non-serving base station, and wherein the second set of SL connection timers for communication establishment comprises timers ‘T300,’ ‘T301,’ and ‘T319.’

17. The processor of claim 11, wherein the additional SIB comprises a twelfth system information block (“SIB12”).

18. The processor of claim 11, wherein the at least one controller is configured to cause the processor to establish a SL Radio Resource Control (“RRC”) connection with the U2N SL relay UE, wherein system information comprising at least the SIB1 is received in a discovery message received from the U2N SL relay UE prior to the establishment of the SL RRC connection or in a RRC reconfiguration message received from the U2N SL relay UE after the establishment of the SL RRC connection.

19. The UE of claim 1, wherein the additional SIB comprises a twelfth system information block (“SIB12”).

20. A method of a User Equipment (“UE”), the method comprising:
receiving a set of connection timers from a first system information block (“SIB”) of a serving node;
receiving a first set of sidelink (“SL”) connection timers from an additional SIB of the serving node;
determining a second set of SL connection timers for communication establishment with a network node using a UE-to-Network (“U2N”) SL relay UE,
wherein a respective value for each timer in the second set of SL connection timers is determined based at least in part on the first set of SL connection timers; and
using a respective connection timer to supervise communication establishment with the network node via the U2N SL relay UE.
